(19) United States
(12) Patent Application Publication
(10) Pub. No.: US 2025/0168515 A1
(43) Pub. Date: May 22, 2025

(54) ON-BOARD CAMERA SYSTEM, AND EXPOSURE CONDITION DETERMINATION METHOD FOR ON-BOARD CAMERA

(71) Applicant: Hitachi Astemo, Ltd., Hitachinaka-shi, Ibaraki (JP)

(72) Inventors: Haruki MATONO, Tokyo (JP); Hideaki KIDO, Tokyo (JP); Kota IRIE, Hitachinaka-shi, Ibaraki (JP)

(73) Assignee: Hitachi Astemo, Ltd., Hitachinaka-shi, Ibaraki (JP)

(21) Appl. No.: 18/841,507

(22) PCT Filed: Jul. 29, 2022
(86) PCT No.: PCT/JP2022/029253

§ 371 Date: Aug. 26, 2024

(30) Foreign Application Priority Data
Mar. 7, 2022 (JP) 2022-034138

(51) Int. Cl. H04N 23/73; G06V 10/141; G06V 20/58; H04N 13/204

(52) U.S. Cl. CPC H04N 23/73; G06V 10/141; G06V 20/58; H04N 13/204

(57) ABSTRACT

Provided is an on-board camera system capable of acquiring accurate three-dimensional information and object recognition information without being affected by a vehicle speed. An on-board camera system including a plurality of cameras arranged on an own vehicle so as to have a stereo vision area in which at least a part of a visual field area is overlapped; a movement amount calculation unit that obtains a movement amount of a feature point of the stereo vision area imaged by the plurality of cameras based on a behavior of the own vehicle; a first exposure condition determination unit that determines a first exposure condition of the plurality of cameras such that the movement amount becomes less than or equal to a threshold value; a second exposure condition determination unit that determines a second exposure condition of the plurality of cameras based on an external light condition of a vehicle exterior; a three-dimensional information acquisition unit that acquires three-dimensional information of the stereo vision area using an image imaged under the first exposure condition; an object recognition unit that recognizes an object around the own vehicle using an image imaged under the second exposure condition; and an exposure control unit that switches an exposure condition of each of the plurality of cameras to the first exposure condition or the second exposure condition.

### TECHNICAL FIELD

The present invention relates to an on-board camera system that recognizes an outside world of an own vehicle using a plurality of cameras in combination, and an exposure condition determination method for an on-board camera.

### BACKGROUND ART

Vehicle control techniques such as adaptive cruise control (ACC), advanced emergency braking system (AEBS), and lane keeping assist system (LKAS) are known as technical elements of a driving assistance system and an automatic driving system. As a specific configuration for realizing these vehicle control technologies, there is known a configuration in which an object (e.g., other vehicles, pedestrians, cyclists, traffic lights, traffic signs, white lines, obstacles, and the like) around an own vehicle is constantly recognized and tracked based on an image imaged by an on-board camera, so that the own vehicle follows a preceding vehicle, an emergency brake is activated, and steering control is performed so as not to deviate from a traveling lane. In addition, vehicles that enable automatic parking by arranging a plurality of cameras so as to be able to monitor not only the front and rear but also the sides of the own vehicle are becoming widespread.

Here, PTL 1 is known as a conventional technique for controlling an exposure time of an on-board camera. In the abstract of this literature, “an image around the vehicle is imaged and displayed in consideration of a traveling state of the vehicle” is described as a problem, and “an on-board camera control device includes vehicle speed acquisition means that acquires a vehicle speed of a vehicle on which an on-board camera is mounted, and camera control means that changes an exposure time of the on-board camera according to the vehicle speed acquired by the vehicle speed acquisition means” is described as a solution. Furthermore, paragraph 0036 of this literature describes “when the vehicle is moving at a high speed, an image around the vehicle can be displayed in real time although the image is not clear”.

### CITATION LIST

### Patent Literature

PTL 1: JP 2008-174078 A

### SUMMARY OF INVENTION

### Technical Problem

As described above, the exposure time control of PTL 1 uniformly changes the exposure time of the on-board camera according to the vehicle speed in order to display the image around the own vehicle in real time, but there is a problem that a clear image cannot be acquired at the time of high-speed movement by this exposure time control. Therefore, when an unclear image imaged by the technique of PTL 1 is used, an object around the own vehicle cannot be accurately recognized, and there is a possibility that vehicle control such as ACC, AEBS, and LKAS cannot be appropriately realized.

Therefore, an object of the present invention is to provide an on-board camera system and an exposure condition determination method for an on-board camera capable of acquiring accurate three-dimensional information and object recognition information necessary for vehicle control such as ACC, AEBS, and LKAS without being affected by a vehicle speed by performing imaging while switching between exposure control for distance measurement and exposure control for object recognition in a time division manner.

### Solution to Problem

In order to solve the above problems, an on-board camera system includes a plurality of cameras arranged on an own vehicle so as to have a stereo vision area in which at least a part of a visual field area is overlapped; a movement amount calculation unit that obtains a movement amount of a feature point of the stereo vision area imaged by the plurality of cameras based on a behavior of the own vehicle; a first exposure condition determination unit that determines a first exposure condition of the plurality of cameras such that the movement amount becomes less than or equal to a threshold value; a second exposure condition determination unit that determines a second exposure condition of the plurality of cameras based on an external light condition of a vehicle exterior; a three-dimensional information acquisition unit that acquires three-dimensional information of the stereo vision area using an image imaged under the first exposure condition; an object recognition unit that recognizes an object around the own vehicle using an image imaged under the second exposure condition; and an exposure control unit that switches an exposure condition of each of the plurality of cameras to the first exposure condition or the second exposure condition.

### Advantageous Effects of Invention

According to the on-board camera system and the exposure condition determination method for the on-board camera of the present invention, three-dimensional information and object recognition information, which are necessary for vehicle control such as ACC, AEBS, and LKAS, without being affected by a vehicle speed by performing imaging while switching the exposure control for distance measurement and the exposure control for object recognition in a time division manner.

### BRIEF DESCRIPTION OF DRAWINGS

FIG. 1 is a functional block diagram of an on-board camera system according to one example.

FIG. 2 is a top view illustrating a relationship between a visual field area and a stereo vision area of each camera.

FIG. 3 is a functional block diagram of a camera control unit in FIG. 1.

FIG. 4 is a processing flowchart of an on-board camera system according to one example.

FIG. 5 is a specific example of a calculation line of three-dimensional information and a calculation region of a feature point movement amount.

### DESCRIPTION OF EMBODIMENTS

Hereinafter, an on-board camera system 100 according to one example of the present invention will be described with reference to the drawings.

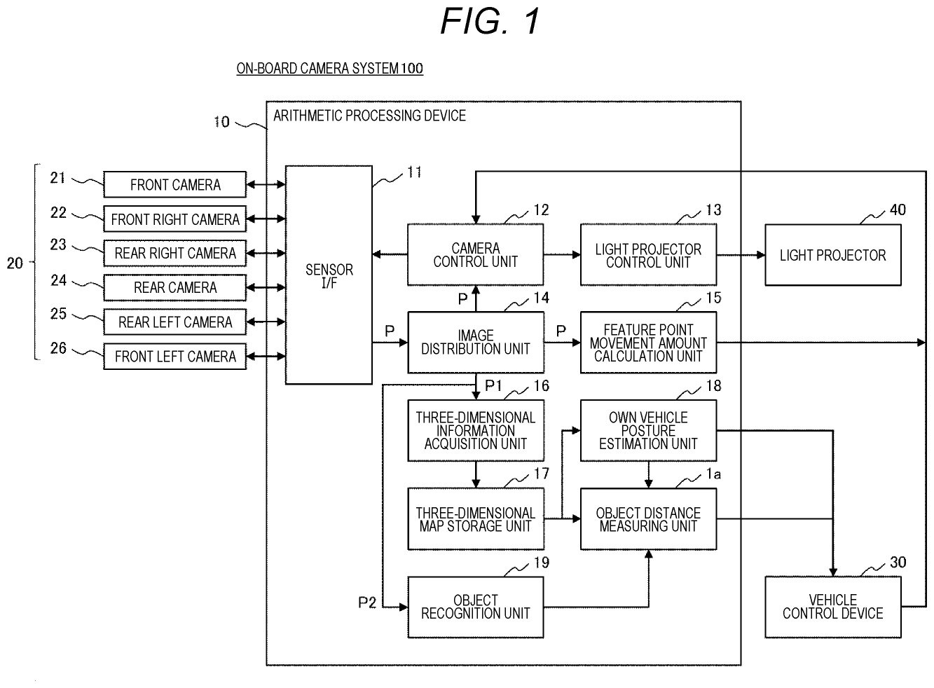

FIG. 1 is a functional block diagram of an on-board camera system 100. The on-board camera system 100 is a system mounted on an own vehicle 1, and includes an arithmetic processing device 10, a camera 20 (21 to 26), a vehicle control device 30, and a light projector 40. Hereinafter, the arithmetic processing device 10 will be described in detail after outlining the camera 20, the vehicle control device 30, and the light projector 40.

### Camera 20

The camera 20 is a sensor that images the periphery of the own vehicle and outputs imaged data P, and a plurality of cameras 20 (21 to 26) are installed in the own vehicle 1 of the present example so as to be able to image the entire periphery of the outside of the vehicle. Note that it is assumed that each camera is installed such that at least a part of an imaging range overlaps with an imaging range of another camera.

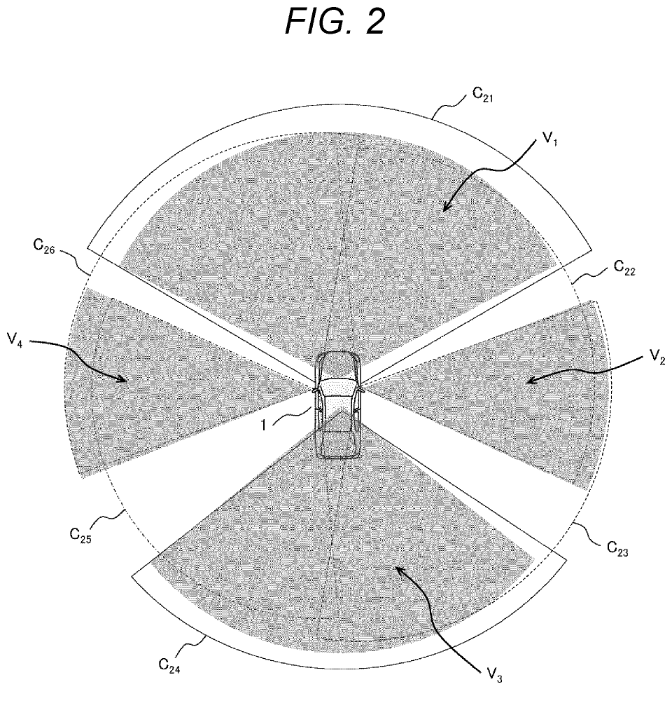

FIG. 2 is a top view of the own vehicle 1, and is a diagram illustrating a relationship between a visual field area C of each camera and a stereo vision area V. In the own vehicle 1 of the present example, a front camera 21 that images a front visual field area C₂₁ indicated by a solid line, a front right camera 22 that images a front right visual field area C₂₂ indicated by a one-dot chain line, a rear right camera 23 that images a rear right visual field area C₂₃ indicated by a broken line, a rear camera 24 that images a rear visual field area C₂₄ indicated by a solid line, a rear left camera 25 that images a rear left visual field area C₂₅ indicated by a one-dot chain line, and a front left camera 26 that images a front left visual field area C₂₆ indicated by a broken line are installed, and the entire periphery of the vehicle exterior can be imaged by these six cameras 20.

In a region where a plurality of visual field areas C overlap, the same object can be imaged from a plurality of visual line directions (stereo imaging), and three-dimensional information of an imaged object (moving body, still object, road surface, etc. around the own vehicle) can be generated by using a well-known stereo matching technique. Therefore, a region where the visual field areas C overlap is referred to as a stereo vision area V.

Note that, in FIG. 2, the front, rear, left, and right stereo vision areas V₁ to V₄ are illustrated, but the number and direction of the stereo vision areas V are not limited to this example. In addition, FIG. 2 illustrates the visual field area C of each camera in a simplified manner, and the actual imageable distance of each camera does not need to have the illustrated magnitude relationship. As an example, the actual imageable distance of each camera is about 200 m for the front camera 21 and the rear camera 24, and about 50 m for the other cameras. In this case, the imageable distance of the stereo vision area V is about 50 m.

### Vehicle Control Device 30

The vehicle control device 30 is a control device that controls a steering system, a drive system, and a braking system (not illustrated) based on a result of object distance measurement described later and the like to execute vehicle control such as ACC, AEBS, LKAS, automatic parking, and the like. Note that the vehicle control device 30 also transmits vehicle speed information of the own vehicle 1 to the camera control unit 12 to be described later, and requests priority transmission of desired information (three-dimensional map, own vehicle posture, object recognition, object distance measurement).

### Light Projector 40

The light projector 40 is a device that projects visible light or near-infrared light at a desired light amount within the range of the stereo vision area V so that each camera can image clearer image data P. When the outside world of the own vehicle 1 is sufficiently bright, the light projector 40 may not be used. In addition, in a case where the light projector 40 is used, constant light projection is not necessary, and light may be projected in synchronization with the imaging timing of each camera.

### Arithmetic Processing Device 10

The arithmetic processing device 10 is a device for acquiring three-dimensional information around the own vehicle, estimating an own vehicle posture, recognizing an object (e.g., other vehicles, pedestrians, cyclists, traffic lights, traffic signs, white lines, obstacles, etc.) around the own vehicle, and measuring a distance to the object based on an output (image data P) of the camera 20. Note that the arithmetic processing device 10 is specifically a computer including an arithmetic device such as a CPU, a storage device such as a semiconductor memory, and hardware such as a communication device. Then, the arithmetic device executes a predetermined program to realize each functional unit such as the camera control unit 12 to be described later, and hereinafter, description will be made while appropriately omitting such a well-known technique.

As illustrated in FIG. 1, the arithmetic processing device 10 of the present example includes a sensor interface 11, a camera control unit 12, a light projector control unit 13, an image distribution unit 14, a feature point movement amount calculation unit 15, a three-dimensional information acquisition unit 16, a three-dimensional map storage unit 17, an own vehicle posture estimation unit 18, an object recognition unit 19, and an object distance measuring unit 1a. Hereinafter, functions of the respective units will be sequentially described.

### Sensor Interface 11

The sensor interface 11 is a functional unit that transmits a command of the camera control unit 12 to the camera 20 (21 to 26), receives the image data P from the camera 20 (21 to 26), and transmits the image data P to the image distribution unit 14. As a result, each camera can image the image data P under the exposure conditions set by the camera control unit 12. Note that details of the exposure conditions will be described later.

### Camera Control Unit 12

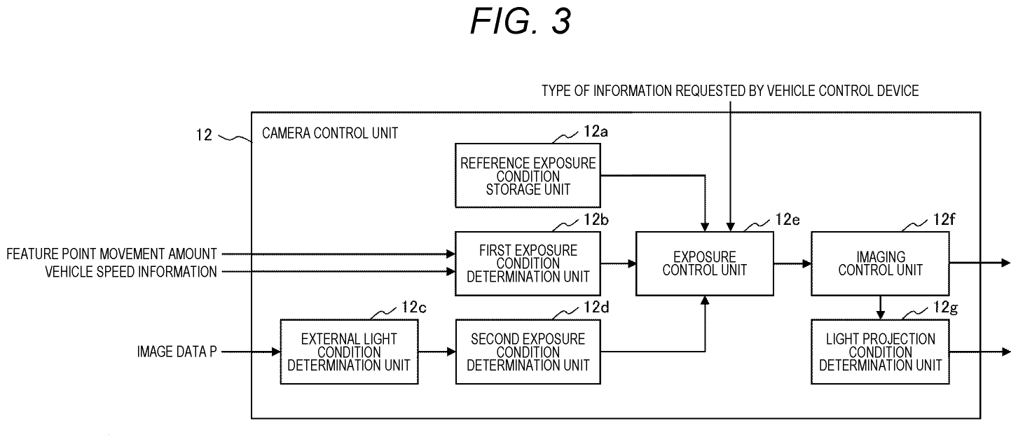

The camera control unit 12 is a functional unit that controls the camera 20 (21 to 26) via the sensor interface 11 and controls the light projector 40 via the light projector control unit 13. As illustrated in FIG. 3, the camera control unit 12 includes a reference exposure condition storage unit 12a, a first exposure condition determination unit 12b, an external light condition determination unit 12c, a second exposure condition determination unit 12d, an exposure control unit 12e, an imaging control unit 12f, and a light projection condition determination unit 12g. Each unit will be described in detail below.

The reference exposure condition storage unit 12a is a functional unit that stores a reference exposure condition (reference exposure time) to be set for each camera when the arithmetic processing device 10 is activated or when the vehicle speed or the vehicle exterior environment is greatly changed.

The first exposure condition determination unit 12b is a functional unit that determines the first exposure condition based on the feature point movement amount received from the feature point movement amount calculation unit 15 described later or the vehicle speed information received from the vehicle control device 30. The first exposure condition defines an exposure time for when imaging image data P1 for acquiring three-dimensional information, and an exposure time in which a feature point movement amount becomes less than or equal to a predetermined threshold value (e.g., two pixels) or an exposure time inversely proportional to a vehicle speed is set.

The external light condition determination unit 12c is a functional unit that determines an external light condition of the vehicle exterior based on luminance information of the image data P received from the image distribution unit 14 described later. Note that, when determining the external light condition, for example, the gain set for each camera and the average luminance in the image data P are taken into consideration. Therefore, even if the average luminance of the image data P is equal, it is determined that the outside world is dark if the gain is high, it is determined that the outside world is bright if the gain is low.

The second exposure condition determination unit 12d is a functional unit that determines the second exposure condition based on the external light condition determined by the external light condition determination unit 12c. The second exposure condition defines an exposure time for when imaging the image data P2 for recognizing the object, and an exposure time substantially inversely proportional to the external light amount is set. The relationship between the external light amount and the second exposure condition may be obtained from a predetermined arithmetic expression, or a table prepared in advance may be referred to.

Note that when the exposure time under the first exposure condition is compared with the exposure time under the second exposure condition, basically, the former is short and the latter is long. Therefore, the image data P1 imaged under the first exposure condition has a disadvantage that the image is dark and thus is not suitable for recognizing an object, but has an advantage that an environmental change around the own vehicle can be quickly detected because the sampling period is short. On the other hand, the image data P2 imaged under the second exposure condition has a disadvantage that it is not suitable for quickly detecting the environmental change around the own vehicle because the sampling period is long, but has an advantage that the image is bright and thus an object can be accurately recognized.

The exposure control unit 12e is a functional unit that selects one of the reference exposure condition, the first exposure condition, and the second exposure condition according to the processing procedure, the vehicle speed, the recognized type, distance, collision possibility, and the like of the object, and transmits the selected one to the imaging control unit 12f. Note that, in the present example, since the exposure conditions of each camera are set in a time division manner while considering the priority application of each camera at that time, the image data P1 for three-dimensional information acquisition and the image data P2 for object recognition are output from each camera at a predetermined ratio. For example, when the priority application of the camera 20 is acquisition of three-dimensional information, such as when the own vehicle 1 is traveling at a high speed or when an object having a possibility of collision is detected, it is only required to image a large number of pieces of image data Pl and a small number of pieces of image data P2 by increasing the usage ratio of the first exposure condition, and when the priority application of the camera is object recognition, it is only required to image a small number of pieces of image data P1 and a large number of pieces of image data P2 by increasing the usage ratio of the second exposure condition.

Furthermore, when the exposure condition is set in consideration of the vehicle speed, the exposure condition is set as follows. For example, when the own vehicle 1 is moving at a constant speed (e.g., 10 km/h) or more, the first exposure condition for acquiring three-dimensional information is preferentially set for each camera. Specifically, the ratio (period or number of times) of setting the first exposure condition to each camera is increased, and the ratio (period or number of times) of setting the second exposure condition is suppressed. On the other hand, when the own vehicle 1 is moving at a speed lower than the constant speed, the second exposure condition for object recognition is preferentially set for each camera.

Here, the same exposure condition needs to be set for the camera group corresponding to the same stereo vision area V, but different exposure conditions may be set at the time of synchronization as long as the stereo vision areas V are different between the cameras. For example, when the own vehicle 1 is moving forward, the first exposure condition for three-dimensional information acquisition may be preferentially set to the camera group (front camera 21, front right camera 22, front left camera 26) corresponding to the front stereo vision area V₁, and the second exposure condition for object recognition may be preferentially set to the camera group (right rear camera 23, rear camera 24, rear left camera 25) corresponding to the rear stereo vision area V_{3.}

The imaging control unit 12f is a functional unit that controls the imaging timing of each camera using the exposure condition set by the exposure control unit 12e. Here, a camera group corresponding to the same stereo vision area V needs to be imaged in synchronization, but imaging timings may be different between cameras having different stereo vision areas V. Therefore, for example, in a case where the same imaging period (e.g., 50 ms) is set to the camera group (21, 22, 26) corresponding to the front stereo vision area V₁ and the camera group (23, 24, 25) corresponding to the rear stereo vision area V₃, a time difference (e.g., 25 ms) corresponding to, for example, a half period may be provided to the former and latter imaging timings. As a result, it is possible to substantially halve the sampling period for imaging the vehicle exterior.

The light projection condition determination unit 12g is a functional unit that determines the light projection timing and the light projection amount of the light projector 40 based on the output of the imaging control unit 12f and transmits the light projection timing and the light projection amount to the light projector control unit 13. As described above, since it is sufficient for the light projector 40 to project light during imaging by each camera, power consumption in the light projector 40 can be suppressed by controlling not to project light during a period in which each camera is not performing imaging.

### Light Projector Control Unit 13

The light projector control unit 13 is a functional unit that controls the light projection of the light projector 40 according to the light projection timing and the light projection amount determined by the light projection condition determination unit 12 g.

### Image Distribution Unit 14

The image distribution unit 14 is a functional unit that distributes the image data P received via the sensor interface 11 to the camera control unit 12, the feature point movement amount calculation unit 15, the three-dimensional information acquisition unit 16, or the object recognition unit 19 according to a control procedure, a traveling situation of the own vehicle 1, a request content of the vehicle control device 30, or the like. Note that it is assumed that information indicating an exposure condition (or exposure time) is added to the image data P so that the type of the image data P can be distinguished by the image distribution unit 14.

### Feature Point Movement Amount Calculation Unit 15

The feature point movement amount calculation unit 15 is a functional unit that calculates a movement amount in the image data P for an arbitrary feature point in the image data P received from the image distribution unit 14.

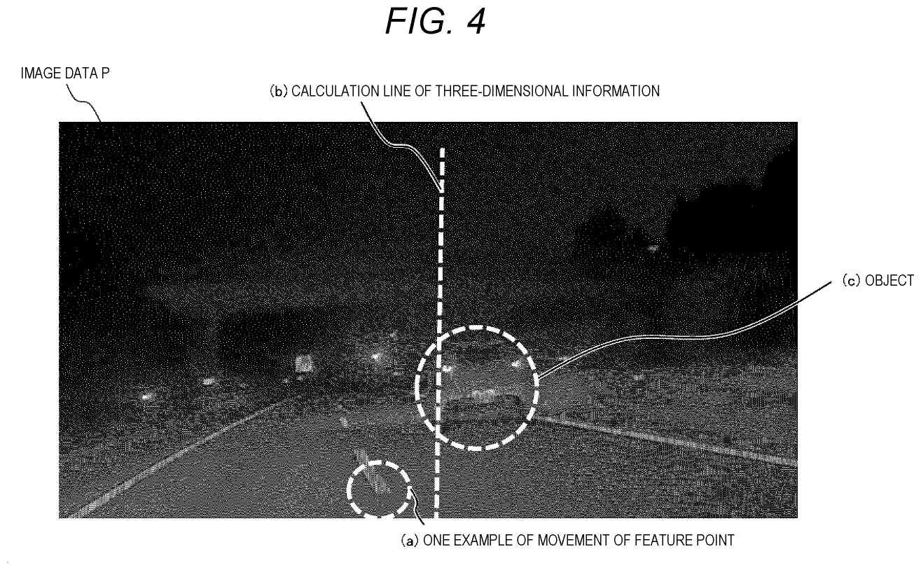

FIG. 4(a) is an example of movement of a feature point in the image data P. As illustrated in the drawing, in a case where the far side end portion of the white line drawn on the road surface is set as the feature point, if the own vehicle 1 is stopped, the boundary between the far side end portion of the white line and the road surface on the fark side is clear, and thus, it can be determined that the movement amount of the feature point is small, but in the image data P of FIG. 4 imaged from the own vehicle 1 traveling at high speed, the boundary between the far side end portion of the white line and the road surface becomes ambiguous, and thus, it can be determined that the movement amount of the feature point is large. Therefore, the feature point movement amount calculation unit 15 calculates the movement amount of the feature point based on the clarity of the image in the vicinity of the feature point. Note that since the movement amount of the feature point is proportional to the vehicle speed, the calculation of the movement amount of the feature point can also be regarded as an approximation of the vehicle speed.

### Three-Dimensional Information Acquisition Unit 16

The three-dimensional information acquisition unit 16 is a functional unit that acquires three-dimensional information for each pixel on an arbitrary calculation line on a set of image data P obtained by synchronously imaging the stereo vision area V using a well-known stereo matching technique.

FIG. 4(b) is a calculation line for acquiring three-dimensional information exemplified in the image data P. In the image data P illustrated in FIG. 4, the sky is imaged in substantially the upper half, and the road surface is imaged in substantially the lower half, so that when a calculation line is set in the vertical direction of the image data P and stereo matching is performed on the calculation line, the closest distance information is calculated for the pixel on the road surface at the lower end of the image data P, the gradually increasing distance information is calculated for the pixel on the road surface from the lower end to substantially the middle of the image data P, and the distance information indicating invalidity (distance unmeasurable) is calculated for the empty pixel from substantially the middle to the upper end. Note that, although only one calculation line is illustrated in FIG. 4, if there is a margin in the calculation capability, a plurality of calculation lines having an arbitrary angle may be set on the image data P, and three-dimensional information may be calculated for each of the calculation lines.

### Three-Dimensional Map Storage Unit 17

The three-dimensional map storage unit 17 is a functional unit that accumulates the three-dimensional information acquired by the three-dimensional information acquisition unit 16 in time series to generate and store a three-dimensional map indicating a road surface gradient, an object, and the like around the own vehicle. Note that, in a case where the past three-dimensional information of the object considered to be a moving object is stored in the three-dimensional map storage unit 17, it is desirable that the first exposure condition is preferentially set for each camera, and the current three-dimensional information of the moving object can be updated, so that the moving object can be tracked.

### Own Vehicle Posture Estimation Unit 18

The own vehicle posture estimation unit 18 is a functional unit that estimates the posture of the own vehicle 1 with respect to the road surface based on the three-dimensional map stored in the three-dimensional map storage unit 17.

### Object Recognition Unit 19

The object recognition unit 19 is a functional unit that recognizes an object imaged in image data P2 using a well-known pattern matching technique.

FIG. 4(c) illustrates an object recognized by the object recognition unit 19 from the image data P. In this example, a preceding vehicle traveling in the own vehicle travel lane and a preceding vehicle traveling in the right lane of the own vehicle travel lane are recognized. In this case, the former is recognized as an object (another vehicle) by pattern matching with an image pattern obtained by imaging the vehicle from the rear, and the latter is recognized as an object (another vehicle) by pattern matching with an image pattern obtained by imaging the vehicle from the left rear.

### Object Distance Measuring Unit 1a

The object distance measuring unit 1a is a functional unit that estimates the distance to the object based on the entire width, the entire height, and the like of the object recognized by object recognition unit 19 in image data P. Note that when the object is within the stereo vision area V, the distance to the object may be calculated using a stereo matching technique, or when the distance to the object is registered in advance as a three-dimensional map, the distance indicated by the three-dimensional map may be adopted as the distance to the object. Since the information on the distance to the object obtained here is transmitted to the vehicle control device 30, the vehicle control device 30 can execute various vehicle controls such as ACC, AEBS, and automatic parking according to the distance to the object.

### Flowchart

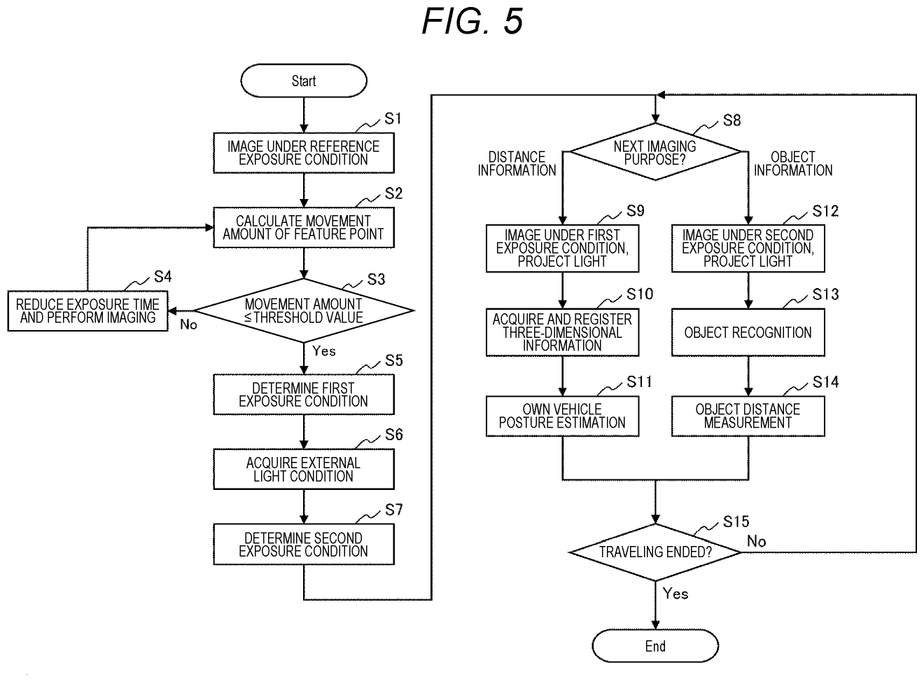

Next, processes of each unit of the on-board camera system 100 described above will be sequentially described with reference to a flowchart of FIG. 5. Here, in order to simplify the description, it is assumed that the brightness of the vehicle exterior is constant and the vehicle speed is also constant.

First, in step S1, the camera control unit 12 (12a, 12e, 12f) sets a reference exposure condition for each camera and causes each camera 20 to image data P.

In step S2, the feature point movement amount calculation unit 15 calculates the feature point movement amount based on the image data P imaged in step S1.

In step S3, the camera control unit 12 (12b) determines whether the calculated feature point movement amount is less than or equal to a predetermined threshold value. Then, if the feature point movement amount is less than or equal to the predetermined threshold value, the process proceeds to step S5, and if not, the process proceeds to step S4.

In step S4, the camera control unit 12 (12b, 12e, 12f) sets a shorter exposure time for the camera 20 and causes the camera to image the image data P. Since the processes of steps S2 and S3 described above are also executed for the newly imaged image data P, the exposure time at which the feature point movement amount becomes less than or equal to the predetermined threshold value is eventually determined.

In step S5, the camera control unit 12 (12b) determines, as the first exposure condition, the exposure time at which the feature point movement amount becomes less than or equal to the predetermined threshold value.

In step S6, the camera control unit 12 (12c) acquires an external light condition of the vehicle exterior based on the image data P.

In step S7, the camera control unit 12 (12d) determines the second exposure condition based on the external light condition.

In step S8, the camera control unit 12 (12e) sets the purpose of the next imaging in consideration of the exposure conditions and the like preferentially set for each camera. When the next imaging purpose is to acquire distance information (three-dimensional information, own vehicle posture information), the process proceeds to step S9, and when the next imaging purpose is to acquire object information (object recognition information, object distance measurement information), the process proceeds to step S12.

In step S9, the camera control unit 12 (12b, 12e, 12f, 12g) sets the first exposure condition to the camera 20 and causes the camera 20 to image the image data P1.

In step S10, the three-dimensional information acquisition unit 16 acquires three-dimensional information based on a plurality of pieces of image data P1 obtained by synchronously imaging the same stereo vision area V. In addition, the acquired three-dimensional information is stored in the three-dimensional map storage unit 17 as a three-dimensional map.

In step S11, the own vehicle posture estimation unit 18 estimates the posture of the own vehicle 1. The estimated own vehicle posture is transmitted to the vehicle control device 30 and used for vehicle control.

On the other hand, in step S12, the camera control unit 12 (12d, 12e, 12f, 12g) sets the second exposure condition to the camera 20 and causes the camera to image the image data P2.

In step S13, the object recognition unit 19 recognizes the object in image data P2.

In step S14, the object distance measuring unit 1a measures the distance to the recognized object. The measured distance to the object is transmitted to the vehicle control device 30 and used for desired vehicle control.

In step S15, the arithmetic processing device 10 determines whether the traveling has ended. Then, if the traveling has not ended, the process returns to step S8 and imaging is continued. As a result, each camera can image the image data P1 and P2 at a predetermined ratio. On the other hand, if the traveling has ended, the process of FIG. 5 is ended. When the brightness of the vehicle exterior or the vehicle speed is greatly changed, the processes from step S1 may be executed again.

According to the on-board camera system of the present example described above, by switching the exposure control for distance measurement and the exposure control for object recognition in a time division manner and performing imaging, accurate three-dimensional information and object recognition information necessary for the vehicle control such as ACC, AEBS, and LKAS can be acquired without being affected by the vehicle speed.

### REFERENCE SIGNS LIST

1 own vehicle
100 on-board camera system
10 arithmetic processing device
11 sensor Interface
12 camera control unit
12a reference exposure condition storage unit
12b first exposure condition determination unit
12c external light condition determination unit
12d second exposure condition determination unit
12e exposure control unit
12f imaging control unit
12g light projection condition determination unit
13 light projector control unit
14 image distribution unit
15 feature point movement amount calculation unit
16 three-dimensional information acquisition unit
17 three-dimensional map storage unit
18 own vehicle posture estimation unit
19 object recognition unit
1a object distance measuring unit
20 (21 to 26) camera
30 vehicle control device
40 light projector
C visual field area
V stereo vision area
P input data

1. An on-board camera system comprising:
a plurality of cameras arranged on an own vehicle so as to have a stereo vision area in which at least a part of a visual field area is overlapped;
a movement amount calculation unit that obtains a movement amount of a feature point of the stereo vision area imaged by the plurality of cameras based on a behavior of the own vehicle;
a first exposure condition determination unit that determines a first exposure condition of the plurality of cameras such that the movement amount becomes less than or equal to a threshold value;
a second exposure condition determination unit that determines a second exposure condition of the plurality of cameras based on an external light condition of a vehicle exterior;
a three-dimensional information acquisition unit that acquires three-dimensional information of the stereo vision area using an image imaged under the first exposure condition;
an object recognition unit that recognizes an object around the own vehicle using an image imaged under the second exposure condition; and
an exposure control unit that switches an exposure condition of each of the plurality of cameras to the first exposure condition or the second exposure condition.

2. The on-board camera system according to claim 1 wherein the exposure control unit prioritizes the first exposure condition over the second exposure condition in a case where a vehicle speed of an own vehicle is greater than or equal to a predetermined value.

3. The on-board camera system according to claim 1, further comprising
a storage unit that stores the three-dimensional information of the stereo vision area acquired in the past by the three-dimensional information acquisition unit in association with an object included in the stereo vision area; wherein
the exposure control unit prioritizes the first exposure condition over the second exposure condition in a case where the three-dimensional information of the object included in the stereo vision area at a current point is stored in the storage unit.

4. The on-board camera system according to claim 1, wherein
the plurality of cameras are arranged so as to have a plurality of the stereo vision areas, and
the exposure control unit switches the first exposure condition and the second exposure condition for each camera group that images each stereo vision area.

5. The on-board camera system according to claim 4, wherein
the exposure control unit prioritizes, in a case where an object having a possibility of colliding with the own vehicle exists in any one of the plurality of stereo vision areas, the first exposure condition over the second exposure condition for a camera that images a stereo vision area in which the object is detected.

6. The on-board camera system according to claim 4, further comprising
an imaging timing control unit that controls an imaging timing such that an imaging timing of a camera that images a first stereo vision area and an imaging timing of a camera that images a second stereo vision area are shifted by a predetermined time among the plurality of cameras, wherein
the three-dimensional information acquisition unit acquires the three-dimensional information based on an image imaged in the first stereo vision area and an image imaged in the second stereo vision area.

7. The on-board camera system according to claim 1, further comprising
a light projector that projects light in synchronization with imaging of the camera.

8. An exposure condition determination method for an on-board camera comprising:
an imaging step of imaging a stereo vision area in which a visual field area of a plurality of cameras is overlapped;
a movement amount calculation step of obtaining a movement amount of a feature point of the stereo vision area imaged by the plurality of cameras based on a behavior of an own vehicle;
a first exposure condition determination step of determining a first exposure condition of the plurality of cameras such that the movement amount becomes less than or equal to a threshold value;
a second exposure condition determination step of determining a second exposure condition of the plurality of cameras based on an external light condition of a vehicle exterior;
a three-dimensional information acquiring step of acquiring three-dimensional information of the stereo vision area using an image imaged under the first exposure condition;
an object recognizing step of recognizing an object around the own vehicle using an image imaged under the second exposure condition; and
an exposure control step of switching an exposure condition of each of the plurality of cameras to the first exposure condition or the second exposure condition.
